(19) United States
(12) Patent Application Publication
(10) Pub. No.: US 2004/0045447 A1
(43) Pub. Date: Mar. 11, 2004

(54) Sanitary hose couplers

(76) Inventor: Ramon Navarro, Orange, CA (US)

Correspondence Address: BRENEMAN & GEORGES, 3150 COMMONWEALTH AVENUE, ALEXANDRIA, VA, 22305, US

(21) Appl. No.: 10/237,440

(22) Filed: Sep. 9, 2002

(51) Int. Cl. A47J 37/12

(52) U.S. Cl. 99/403

(57) ABSTRACT

A sanitary hose coupler attachable in a fluid pressure-tight, void-free connection to a resiliently deformable hose for conveying liquid food or drug products under pressure, which is releasably coupleable in a fluid pressure-tight connection to a compatible coupler, comprises an elongated tubular connector body having a rearwardly protruding frusto-conically tapered nose piece forcibly insertable into the bore of a hose, a hollow cylindrical compression member which has through its length a central frusto-conically shaped bore and a clamping member for exerting a compression force couple on the compression member and connector body, thereby pressing the tapered inner wall surface of the compression member into a fluid pressure-tight seal with the outer surface of an end portion of the hose which is expanded by insertion of the nose piece into the hose bore.

### BACKGROUND OF THE INVENTION

A. Field of the Invention The present invention relates to fittings for use with flexible hoses used to transport liquid food products under pressure. More particularly the invention relates to sanitary hose couplers attachable to hoses and releasably joinable together in a fluid pressure-tight connection.

B. Description of Background Art

In the manufacture and packaging of liquid food products and pharmaceuticals, flexible hoses are used extensively for transporting liquid products under pressure between various processing and container-filling stations. Such liquid products have different viscosities, ranging from typically low viscosities for beverages, to relatively high viscosities for products such as jellies. Accordingly, hoses and hose fittings used for such applications must withstand the relatively high pressures required for transporting liquid materials at reasonably high flow rates.

Hose and hose fittings used in the food and drug industries for transporting liquid food and drug products, especially those intended for human consumption, must meet certain performance requirements in addition to maintaining a leak-tight connection under pressure, as alluded to above. For example, U.S. Food and Drug Administration (FDA) regulations require that machines used to fill containers with liquid food or drug products must be sterilizable, and readily cleaned of liquid products which might be trapped in cavities within machine components, and thereby providing a growth media for microbes. Accordingly, a goal in the design and construction of machines used for the processing or handling liquid food and drug products, such as production line container filling machines, is that such machines be Cleanable-In-Place (C.I.P.), with no or minimal disassembly of machine components required during the cleaning process. Since hoses used to transport liquid food or drug products between various production processing machines must also be periodically cleaned, the ends of such hoses are generally fitted with a connecting element or coupler which is releasably joinable to a compatible coupler attached to a machine component or to another hose.

A variety of hoses fitted with couplers on one or both ends are available. Some types of existing couplers are permanently attached to hoses, usually at a factory which manufactures the coupler. Other types of currently available coupler fittings are reusable, and some are attachable to hoses in the field. Field attachability of hose fittings is desirable since it enables such fittings to be attached to the ends of hoses which are cut to a particular length at a location where the fitting is to be used, such as a liquid food or drug processing production line.

Many existing hose fittings and couplers for use with flexible hoses include a tubular component or ferrule member which has a plurality of longitudinally spaced apart circumferentially disposed, radially outwardly projecting gripping members such as annular rings or ridges, barbs or ribs which are provided to grip the inner circumferential wall surface of the hose and secure the fitting to the hose, when the tubular component is press fitted into the hose bore. However, that type of fitting is problematic for use in the food and drug industries, for the following reason.

Initially, gripping members on the exterior surface of a tubular fitting element press-fitted into the bore of a flexible hose usually form an adequate fluid-pressure-tight seal with the inner cylindrical surface of the hose bore wall. Moreover, since most such tubular elements have a plurality of longitudinally spaced apart gripping members, leakage of fluid under pressure, or blow-by, around a single gripping element will not necessarily cause a breach of the fluid-tight pressure seal which would allow leakage of fluid product to the outside of the hose, since the other gripping members spaced longitudinally inwards of an outer gripping element provide redundant, back-up fluid pressure-tight seals. However, it has been found that, cyclically pressurizing and de-pressurizing such existing hose fittings with liquid product can cause the following problem.

When a hose is pressurized, expansion of the hose outwards from the gripping elements of a hose fitting may allow liquid product to flow longitudinally inwardly beyond one or more seals made by the gripping elements. Then, when the hose is de-pressurized, the hose contracts, trapping liquid food product that has leaked by the sealing elements, in the valleys, grooves or other such cavities which separate the sealing elements. Thus, presently existing hose fittings including couplers which utilize external gripping members on the outer surface of a tubular press-fit fitting component generally have cavities in which liquid products may be trapped, and are therefore, not truly cleanable-in-place. The unavailability of a sanitary hose coupler meeting all of the above mentioned criteria of being cleanable-inplace, readily attachable to the end of a hose in the field, and readily connected and disconnected to a compatible coupler attached to another hose or to a machine component, was a motivation for the present invention.

### OBJECTS OF THE INVENTION

An object of the present invention is to provide a sanitary hose coupler for liquid products which is fastenable to a flexible hose to form therewith a fluid pressure-tight flow path devoid of cavities which might trap a portion of liquid product flowing through the hose.

Another object of the invention is to provide a sanitary tubular hose coupler which has a first, outer longitudinal end portion sealably and releasably coupleable to the outer end portion of another coupler.

Another object of the invention is to provide a re-attachable sanitary hose coupler which has a first, outer longitudinal end portion sealably and releasably coupleable to the outer end portion of another coupler, and a second, inner longitudinal end portion which is removably attachable in a fluid pressure-tight connection to an end of a flexible hose.

Another object of the invention is to provide a sanitary hose coupler which has a first, outer longitudinal end portion sealably and releasably coupleable to the outer end portion of another coupler, and a second, inner longitudinal end portion which is permanently attachable in a fluid pressure-tight connection to an end of a flexible hose.

Various other objects and advantages of the present invention, and its most novel features, will become apparent to those skilled in the art by perusing the accompanying specification, drawings and claims.

It is to be understood that although the invention disclosed herein is fully capable of achieving the objects and providing the advantages described, the characteristics of the invention described herein are merely illustrative of the preferred embodiments. Accordingly, I do not intend that the scope of my exclusive rights and privileges in the invention be limited to details of the embodiments described. I do intend that equivalents, adaptations and modifications of the invention reasonably inferable from the description contained herein be included within the scope of the invention as defined by the appended claims.

### SUMMARY OF THE INVENTION

Briefly stated, the present invention comprehends sanitary hose couplers for attachment to flexible hoses used to transport liquid products under pressure. Hose couplers according to the present invention have a first, inner longitudinal end portion which includes an attachment structure adapted to make a fluid pressure-tight seal with the end of a flexible hose, and a second, outer longitudinal end portion which includes a connector flange adapted to be releasably coupled to another coupler which has a mating flange, the other coupler being either another coupler according to the present invention, or a coupler of an existing type which has a suitable connection flange.

A first, re-attachable or removably attachable embodiment of a sanitary hose coupler according to the present invention includes a longitudinally elongated circular cross section connector body having disposed through its length a coaxial bore. The connector body has a relatively short cylindrically-shaped tubular portion which is terminated at a front or outer longitudinal end thereof by an annular ring-shaped front connector flange that has a front or outer transverse face in which is formed a concentric annular ring-shaped groove. The connector flange has a short cylindrical body which is joined at a rear or inner end thereof to the tubular portion of the body by a frusto-conically-shaped shoulder. The connector body includes an elongated externally threaded cylindrical section located longitudinally inwards of the short tubular section. The threaded cylindrical section has a rear or longitudinally inwardly located, annular ring-shaped transverse end with which forms a shoulder. A radially inwardly tapered, elongated frusto-conic nose section protrudes rearwardly from the shoulder. The nose section has a smooth outer wall surface and is of the proper size to be insertably receivable into the bore of a flexible hose or tube sufficiently far for the transverse outer annular end wall of the hose to butt up against the rear surface of the shoulder of the threaded portion of the connector body. Inserting the frusto-conically tapered nose of the connector body into the bore of a resiliently deformable hose distorts the inner and outer wall surfaces of the hose into generally frusto-conic shapes.

A re-aftachable sanitary hose coupler according to the present invention also includes a compression ring which has a cylindrical outer surface, an annular ring-shaped inner transverse end wall, and a frusto-conic inner wall surface which tapers radially outwardly in a forward longitudinal direction to a front or outer transverse end wall of larger inner diameter than the inner transverse end wall. The tapered inner wall surface of the compression ring is segmented into a longitudinally disposed sequence of radially inwardly protruding, annular ring-shaped ridges. The ridges are of stepped diameter and approximately equal length. Each of the ridges has a frusto-conically-shaped longitudinal cross section, which tapers radially outwardly from the rear or inner transverse end wall of the compression ring, to a front or outer transverse end wall of larger inner diameter than the rear transverse end wall.

Each adjacent pair of frusto-conically contoured, annular ring-shaped ridges in the inner cylindrical wall surface of the compression ring has located therebetween a radially outwardly protruding groove which has a generally triangularly-shaped longitudinal cross section, the groove having a stepped shoulder which intersects an adjacent ridge.

A re-attachable sanitary hose coupler according to the present invention includes as a third component, an elongated cylindrically-shaped compression nut or bushing. The compression nut has at a rear or inner longitudinal end thereof a transversely disposed flat, annular ring-shaped flange wall. The rear end transverse flange wall has through its thickness dimension a central coaxial hose bore of the proper diameter to provide clearance for the largest outer diameter hose which the coupler is intended to be used with. The hose bore in the rear flange wall communicates with a rear hollow cylindrical space within the interior of the compression nut, which has a smooth inner wall that has an inner diameter greater than the outer diameter of the compression ring, and a length greater than that of the compression ring. Located longitudinally forward of the rear, smooth-bore portion of the compression nut is a front, internally threaded cylindrical portion. The latter has formed in the inner cylindrical wall surface thereof internal helical threads which are disposed longitudinally forward from the rear smooth-bore portion of the compression nut to the front or outer longitudinal end thereof, and are of the proper size and pitch to threadably receive the external threads on the connector body.

The re-attachable sanitary hose coupler according to the present invention is attached to the free end of a flexible hose as follows. First, the end of the hose is inserted forwardly into the hose bore of the compression nut, and forwardly into the hose bore of the compression ring. The nose piece of the connector body is then forcibly inserted longitudinally rearwards into the hose bore, deforming both inner and outer walls of an end portion of the hose from generally cylindrical shapes to generally frusto-conic shapes. The compression nut is then slid forward over the compression ring and hose sufficiently far for the external threads of the connector body to contact the internal threads of the compression nut. Relative torque is then applied between the compression nut and connector body, to thread the connector body rearwardly into the compression nut. The ensuing longitudinal contraction of the space between the rear shoulder of the threaded portion of the coupler body, and the front surface of the rear compression nut flange wall, causes the compression nut flange wall to press in a longitudinally forward direction on the rear end wall of the compression ring. This force in turn causes the ridged, frusto-conically-shaped inner wall of the compression ring to press tightly into the expanded outer wall surface of the hose end, thus causing the shoulders of the ridges to dig into the outer wall surface of the hose, and the outer wall surface of the hose to deform by cold flow into the grooves between the ridges. Thus installed, the re-attachable sanitary coupler according to the present invention forms a fluid pressure-tight seal with the hose, devoid of any cavities in the flow path through the coupler which might trap flowing liquid product.

A second, permanently attached embodiment of a sanitary hose coupler according to the present invention is of simpler construction than the re-attachable embodiment described above, and has only two component parts, which consist of a connector body of simplified construction, and an external compression sleeve which combines functions of the compression ring and compression nut of the re-attachable embodiment of the hose coupler described above.

The connector body of a permanently attachable hose coupler according to the present invention has a relatively short cylindrically-shaped tubular portion which is terminated at a front or outer longitudinal end thereof by an annular ring-shaped, front or outer connector flange that has a front or outer transverse face in which is formed a concentric annular ring-shaped groove. The front connector flange has a short cylindrical body which is joined at a rear or inner longitudinal end thereof to the tubular portion of the connector body by a frusto-conically-shaped shoulder. The front tubular portion of the connector body is terminated at a rear or inner longitudinal end thereof by a radially outwardly protruding, annular ring-shaped rear locking flange, which has a rear transversely disposed shoulder. A radially inwardly tapered, elongated frusto-conic nose section protrudes rearwardly from the shoulder. The nose section has a smooth outer wall surface of the proper size to be insertably receivable into the bore of a flexible hose or tube sufficiently far for the front or outer transverse annular end wall of the hose to butt up against the shoulder of the rear locking flange. Inserting the nose of the connector body into the bore of a resiliently deformable hose distorts the inner and outer wall surfaces of the hose into generally frusto-conic shapes.

A permanently attachable sanitary hose coupler according to the present invention also includes a compression sleeve which has a cylindrical outer surface, an annular ring-shaped rear transverse end wall at the rear or inner longitudinal end of the sleeve, and a generally frusto-conically-shaped inner circumferential wall surface which tapers radially outwardly in a forward longitudinal direction to a front or outer transverse end wall of larger inner diameter than the rear or inner transverse end wall. The tapered inner wall surface of the compression sleeve is segmented into a longitudinally disposed sequence of radially inwardly protruding, annular ring-shaped ridges. The ridges are of stepped diameter and approximately equal length. Each of the ridges has a frusto-conically-shaped longitudinal cross section, which tapers radially outwardly from the rear or inner transverse end wall of the compression ring, to a front or outer transverse end wall of larger inner diameter than the rear transverse end wall.

Each adjacent pair of frusto-conically contoured, annular ring-shaped ridges in the inner cylindrical wall surface of the compression sleeve has located therebetween a radially outwardly protruding groove which has a generally triangularly-shaped longitudinal cross section, the groove having a stepped shoulder which intersects an adjacent ridge.

The permanently attachable sanitary hose coupler according to the present invention is attached to the free end of a flexible hose as follows. First, the end of a flexible hose is inserted into the rear hose bore of the compression sleeve. The nose piece of the connector body is then forcibly inserted longitudinally rearwardly into the hose bore, deforming both the inner and outer walls of an end portion of the hose located rearwards or inwards of the outer transverse end face of the hose, from generally cylindrical to generally frusto-conic shapes. The compression sleeve is then advanced forward forcibly against the deformed outer wall surface of the end portion of the hose, by using a press or similar tool, sufficiently far for the front annular edge wall of the compression sleeve to move longitudinally forward or outwards of the front annular transverse surface of the rear locking flange of the connector body. This forcing action causes the ridged, frusto-conically-shaped inner wall surface of the compression sleeve to press tightly into the radially expanded and frusto-conically deformed outer wall surface of the hose end, thus causing the shoulders of the ridges protruding radially inwards from the inner wall surface of the sleeve to dig into the outer wall surface of the hose, and the outer wall surface of the hose to deform by cold flow into the grooves between the ridges.

A final step in installing the permanently attachable sanitary hose coupler to the hose consists of permanently deforming an outer end portion of the cylindrical wall of the compression sleeve radially inwardly to form an angled annular locking lip flange which presses against the front surface of the rear connector body locking flange, thereby permanently securing the compression sleeve into locking engagement with the connector body. Deformation of the front end wall of the compression sleeve to form the annular locking lip flange is accomplished by impacting the front end wall with a punch which has in a front surface thereof a notch shaped complementarily to the desired outer contour of the lip flange, the rear surface of the punch being impacted by a hammer as the hammer and punch are orbited circumferentially around the sleeve end wall. Alternatively, the compression sleeve end wall can be deformed by a ring-shaped die, which may optionally be incorporated into the press used to press the compression sleeve and connector body together.

With the connector body and compression sleeve of the permanently attachable sanitary hose coupler attached to a hose as described above, the hose and coupler are joined together in a permanent fluid pressure-tight seal, devoid of any cavities in the path of liquid flowing product flowing through the hose and coupler, which cavities might trap flowing liquid products.

### BRIEF DESCRIPTION OF THE DRAWINGS

FIG. 1 is an exploded perspective view of a removably attachable embodiment of a sanitary hose coupler according to the present invention, showing the coupler oriented for attachment to a first hose segment, and adjacent to a mating coupler already attached to a second hose segment.

FIG. 2A is a longitudinal sectional view of the coupler of FIG. 1, taken in the direction of line 2A-2A.

FIG. 2B is a fragmentary view of the coupler of FIG. 2A on an enlarged scale, taken in the direction of line 2B-2B.

FIGS. 3A-3D are left side elevation views of the hose and three components of the coupler of FIG. 1, taken in the directions 3A-3A, 3B-3B, 3C-3C, and 3D-3D, respectively.

FIGS. 4A-4D are right side elevation views of the hose and three components of the coupler of FIGS. 1, taken in the directions 4A-4A, 4B-4B, 4C-4C, and 4D-4D, respectively.

FIGS. 5A-5D are perspective views showing a method of attaching the coupler of FIGS. 1 and 2 to a hose segment, in which FIG. 5A shows a compression nut and compression ring slipped over the end of a hose, FIG. 5B shows a connector body inserted into the hose bore, FIG. 5C shows a clamp installed on the connector body to facilitate applying a counter torque to the connector body, and FIG. 5D shows a wrench being used to exert a tightening torque on the compression nut.

FIG. 6 is a longitudinal sectional view of the coupler of FIG. 5, showing the coupler of FIGS. 1 and 2 removably attached to a hose segment.

FIG. 7 is an exploded perspective view of a permanently attachable embodiment of a sanitary hose coupler according to the present invention.

FIG. 8 is a longitudinal sectional view of the coupler of FIG. 7, taken in the direction of line 8-8.

FIGS. 9A-9C are left side elevation views of the hose and two components of the coupler of FIG. 7, taken in the directions 9A-9A, 9B-9B, and 9C-9C, respectively.

FIGS. 10A-10C are right side elevation views of the hose and two components of the coupler of FIG. 7, taken in the directions 10A-10A, 10B-10B, and 10C-10C, respectively.

FIGS. 11A-11D are perspective views showing a method of attaching the coupler of FIGS. 7 and 8 to a hose segment, in which FIG. 11A shows a compression sleeve slipped over the end of a hose, FIG. 11B shows a connector body inserted into the hose bore, FIG. 11C shows the compression sleeve pressed forward to overlie a rear flange of the connector body, and FIG. 11D shows a front transverse end wall of the compression sleeve deformed radially inwardly over the rear flange of the connector body to permanently secure the coupler to the hose.

FIG. 12 is a longitudinal sectional view of the coupler of FIG. 11, showing the coupler permanently attached to a hose segment.

FIG. 13 is a view of a press which is useable to attach the coupler of FIGS. 7-12 to a hose.

FIG. 14 is a fragmentary vertical longitudinal sectional view of the press of FIG. 13, taken in the direction of line 14A-14A.

FIG. 14B is a fragmentary horizontal transverse sectional view of the press of FIG. 13 taken in the direction of line 14B-14B.

FIG. 15 is a longitudinal vertical sectional view of the press of FIG. 13, taken in the direction of line 15-15 and showing the manner at forming a locking lip flange on the coupler.

### DESCRIPTION OF THE PREFERRED EMBODIMENTS

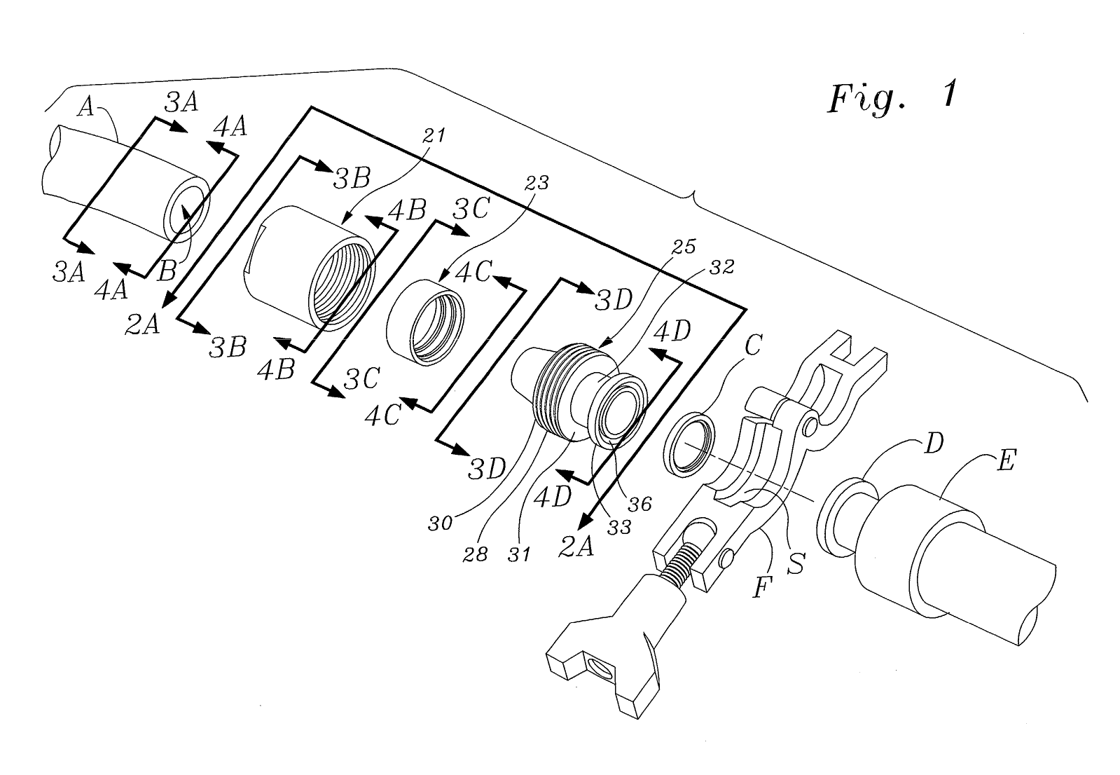

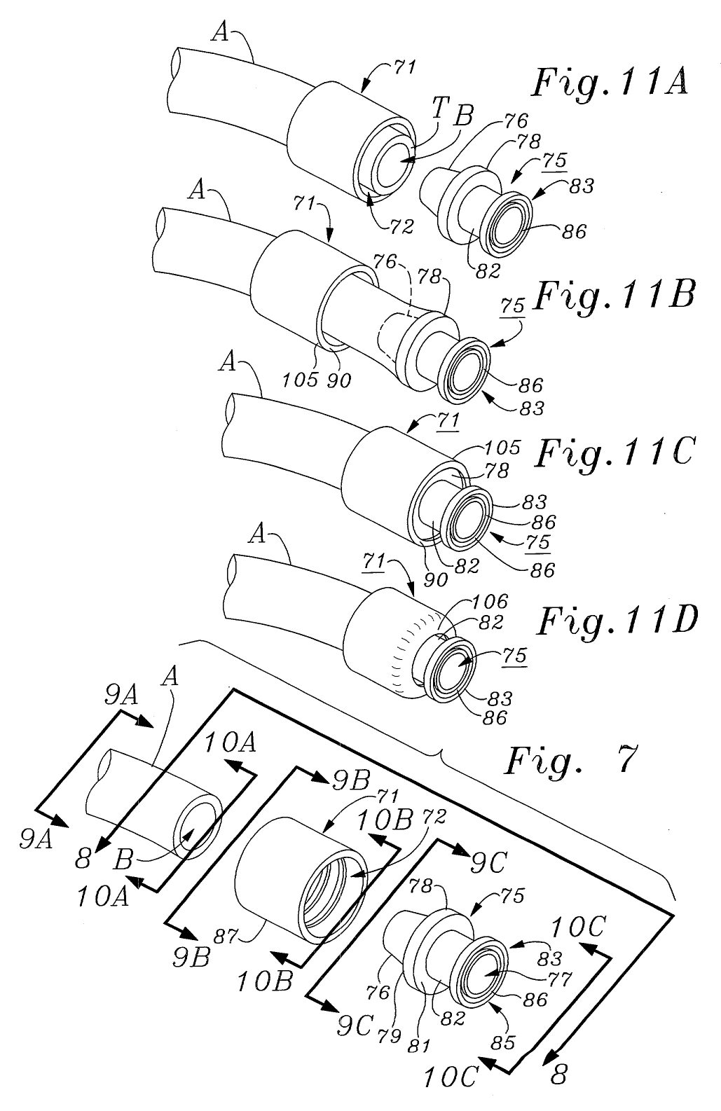

FIGS. 1-6 illustrate various aspects of a removably attachable sanitary hose coupler according to the present invention, and FIGS. 7-12 illustrate a permanently attachable embodiment of the invention.

Referring first to FIGS. 1-4, a removably attachable sanitary hose coupler 20 according to the present invention may be seen to include a coaxially alignable set of three circularly symmetric component parts, including a rear compression nut 21 which as through its length a longitudinally disposed circular bore 22 which is adapted to insertably and loosely receive a hose A, a longitudinally intermediately located compression ring 23 which has through its length a longitudinally disposed circular bore 24 which is adapted to insertably and snugly receive a hose A, the outer diameter of the compression ring being smaller than bore 22 of the compression nut, and a front or longitudinally outwardly located connector body 25 which has a rear radially inwardly tapered frusto-conic nose piece 26 which is adapted to be forcibly inserted into the bore B of hose A.

As shown in FIGS. 1, 2, 3D and 4D connector body 25 has a hollow tubular shape and has disposed longitudinally through its length a cylindrical circular bore 27 of uniform diameter. Connector body 25 includes an elongated, externally threaded, intermediate cylindrical portion 28, the intermediate portion having an annular ring-shaped, transversely disposed rear end face 29 which forms a shoulder that joins the front longitudinal end of the nose piece.

Intermediate cylindrical portion 28 of connector body 25 has formed in an outer cylindrical wall surface thereof a helically disposed thread 30. Also, intermediate threaded portion 28 of connector body 25 has an annular ring-shaped, transversely disposed front end face 31 which joins the threaded intermediate portion to a short front, cylindrically-shaped tubular portion 32. The latter has a smooth outer cylindrical wall surface of a uniform outer diameter approximately the same as the outer diameter of the front end of rear frusto-conically-shaped nose piece 26. Front tubular portion 32 of connector body 25 is terminated at a front or longitudinally outwardly located or front end thereof by an annular ring-shaped front connector flange 33. The latter has a frusto-conically-shaped rear transverse end wall 34, and a flat front transverse end wall 35, in which is formed a concentric annular ring-shaped groove 36. Groove 36 is provided for receiving an O-ring C, adapting flange 33 to make a compressive fluid pressure-tight seal with the flange D of another hose coupler E, when the two flanges are pressed towards one another, as by a toggle clamp F. Coupler E may be of a conventional prior art design, or a coupler according to the present invention.

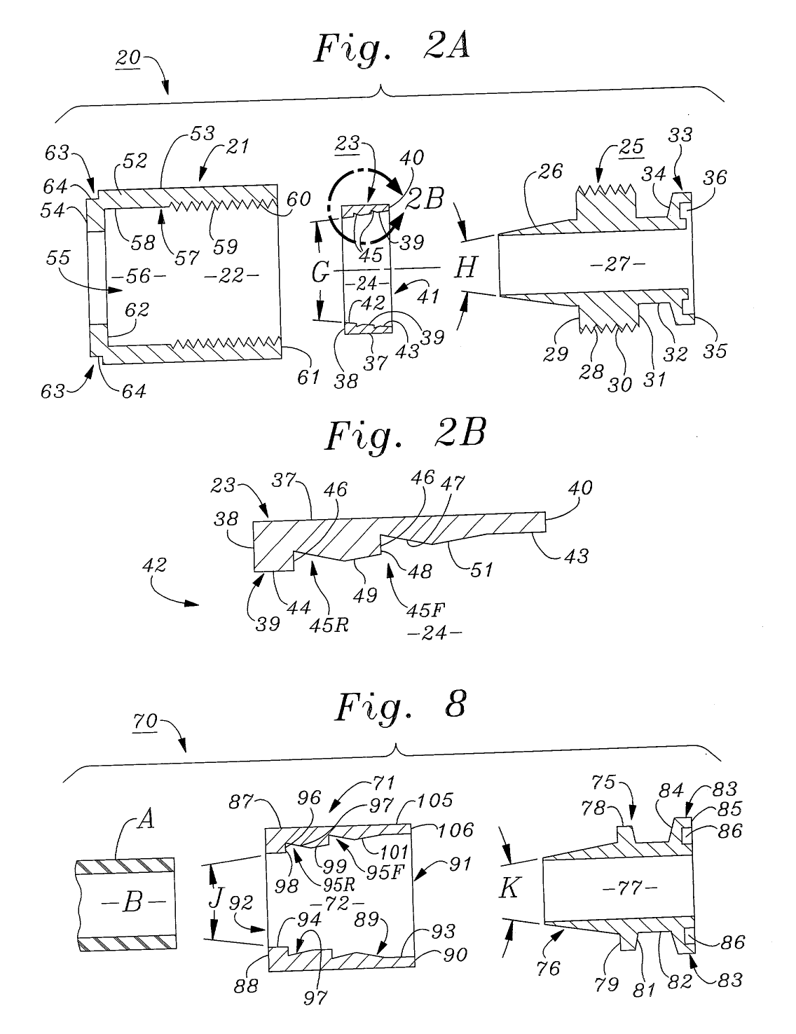

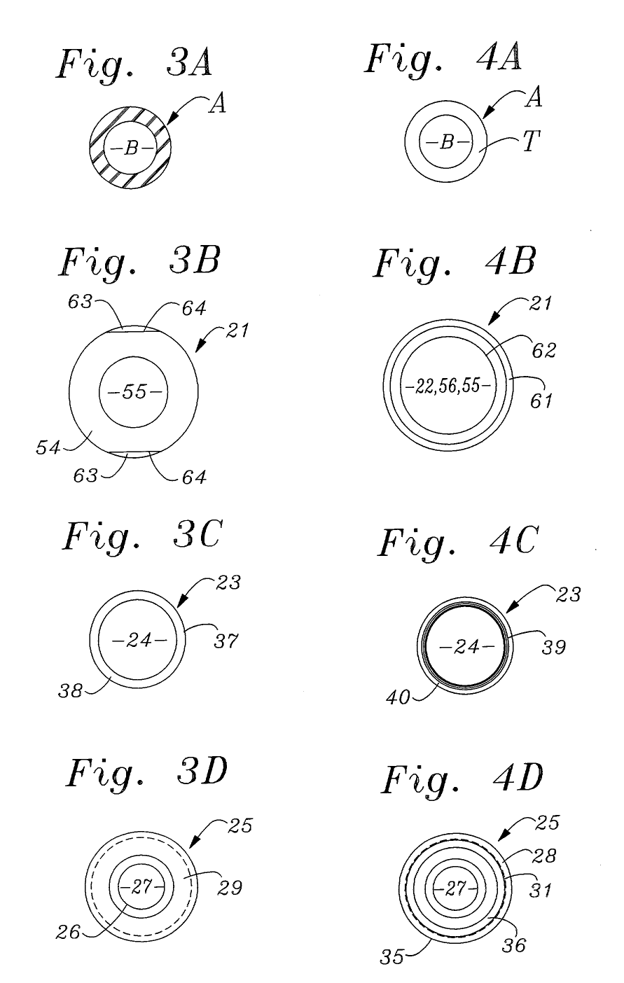

Referring now to FIGS. 3C and 4C in addition to FIGS. 1 and 2, it may be seen that compression ring 23 of removably attachable hose coupler 20 according to the present invention has a cylindrical outer surface 37, a rear or inner longitudinally located transverse end wall 38, and a frusto-conically tapered inner wall surface 39 which tapers radially outwardly to a front or outer longitudinal transverse end wall 40 which has a larger inner diameter than the rear transverse end wall. As shown in FIG. 2, the cone angle G of tapered inner wall surface 39 is preferably larger than that of cone angle H of connector body nose piece 26, for a reason which will be described below. In an example embodiment of coupler 20, tapered inner wall surface 39 of compression ring 23 had a cone angle G of about 7 degrees ±2 degrees, and connector body nose piece 26 had a cone angle H of about 6 degrees ±2 degrees, for a hose made of reinforced silicone or Teflon® and having an inner diameter of ⅝ inches and a wall thickness of about 0.170 inch. It is believed that the cone angles G and H should be increased about one degree for each inch increase in the inner diameter of hose A. However, hoses made of harder, less flexible materials such as Teflon® require somewhat smaller cone angles. In any event, the exact value of cone angles is not extremely critical, and the adjustment of the cone angles to suite hose materials of a given pliability may be readily made by those skilled in the art, in view of the present disclosure.

Referring still to FIG. 2, it may be seen that the frusto-conic shape of tapered inner wall surface 39 of compression ring 23 is preferably modified by cylindrical front and rear entrance counter bores 41 and 42, respectively, which form relatively short, cylindrically shaped, untapered portions 43 and 44, respectively, in tapered inner wall surface 39. As shown in FIG. 2, tapered inner wall surface 39 of compression ring 23 has formed therein a longitudinally spaced apart sequence of radially inwardly protruding, annular ring-shaped, triangular cross section grooves 45. Each groove 45 has a generally transversely disposed rear edge 46, and a longer oblique edge 47 which angles radially outwardly and forward from the rear edge to an uncut portion of inner wall surface 39. Thus, each groove 45 has at a rear or inner longitudinal end thereof a shoulder 48 formed by the intersection of transversely disposed rear edge 46 of the groove with tapered inner wall surface 39. Shoulder 48 has a relatively sharp vertex angle, being about 90 degrees plus one-half the cone angle G. On the other hand, oblique edge 47 of each groove 45 intersects tapered inner wall surface 39 at a relatively large obtuse angle.

The uncut portion of tapered inner wall surface 39 between each intersection of an oblique side 47 of groove 45 with the inner wall surface, and the rear transverse edge wall 46 of an adjacent, longitudinally outwardly spaced apart groove, forms a ridge 49. Although the exact number of grooves 45 formed in inner tapered wall surface 39 of compression ring 23 is not critical, preferably as shown in FIG. 2, the compression ring has at least two longitudinally spaced apart grooves 45 which form therebetween a ridge 49. It should be noted that tapered, uncut portion 50 in inner wall surface 39 rearward of the rear groove 45R, and tapered, uncut portion 51 of inner wall surface 39 forward of front groove 45F has a shapes similar to that of ridges 49, and serves a similar function, as will be described in detail below.

Referring now to FIGS. 3B and 4B in addition to FIGS. 1 and 2, it may be seen that compression nut 21 of removably attachable hose coupler 20 has the shape of a longitudinally elongated bushing which includes a cylindrical body 52 that has an outer cylindrical wall surface 53 of uniform circular transverse cross section. Body 52 of compression nut 21 is terminated at a rear or inner longitudinal end thereof by a transversely disposed, flat, annular ring-shaped flange wall 54. Flange wall 54 has through its thickness dimension a central coaxial hose bore 55 of the proper diameter to provide clearance for the largest outer diameter hose which coupler 20 is intended to be used with. Hose bore 55 communicates with a hollow cylindrically-shaped space 56 within compression nut body 52. The inner cylindrical wall surface 57 of compression nut body 52 has a rear longitudinal portion 58 which has a smooth bore of larger diameter than the outer diameter of compression ring 28, and a length greater than that of the compression ring. Inner cylindrical wall surface 57 of compression nut body 52 also has a front longitudinal portion 59 in which is formed a helical thread 60 that is disposed forward from rear smooth bore portion 58 to a front transverse end wall 61 of body 52. Internally threaded portion 59 of compression nut body 52 is of the proper size and pitch to insertably and threadably receive externally threaded portion 28 of connector body 25. As shown in FIG. 2, rear flange wall 54 of compression nut 21 has an annular ring-shaped front wall surface 62. Also, as may be seen best by referring to FIGS. 2 and 3B, rear transverse end wall 54 has formed therein a pair of diametrically opposed, transversely disposed notches 63 which have parallel, longitudinally disposed, radially inwardly recessed flat edges or flats 64.

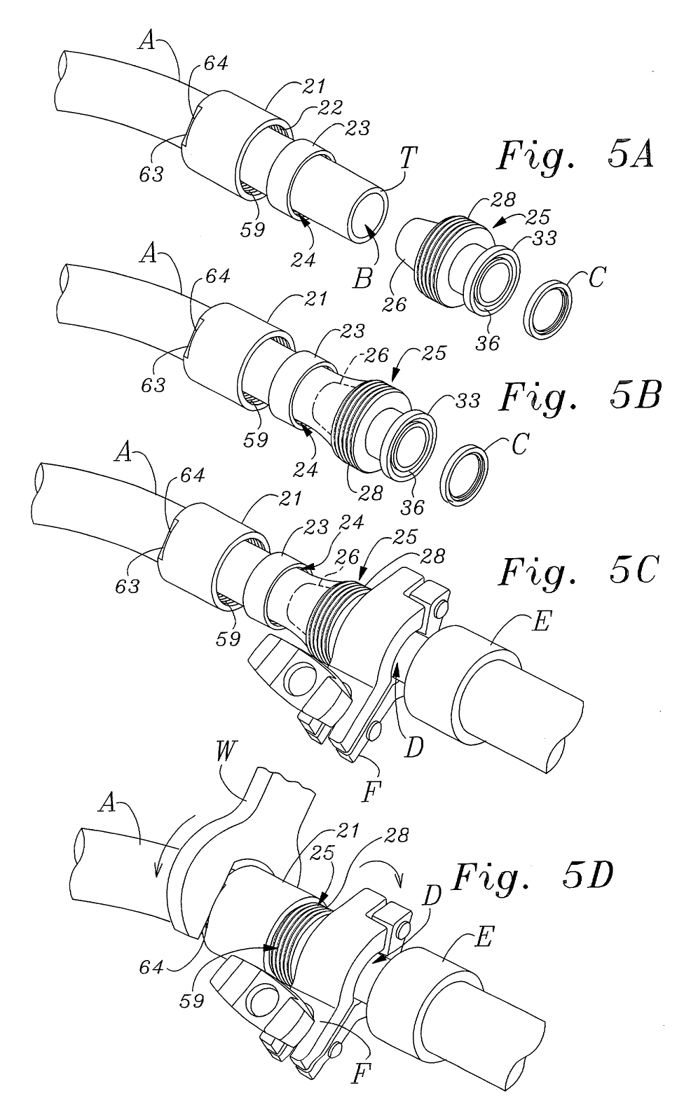

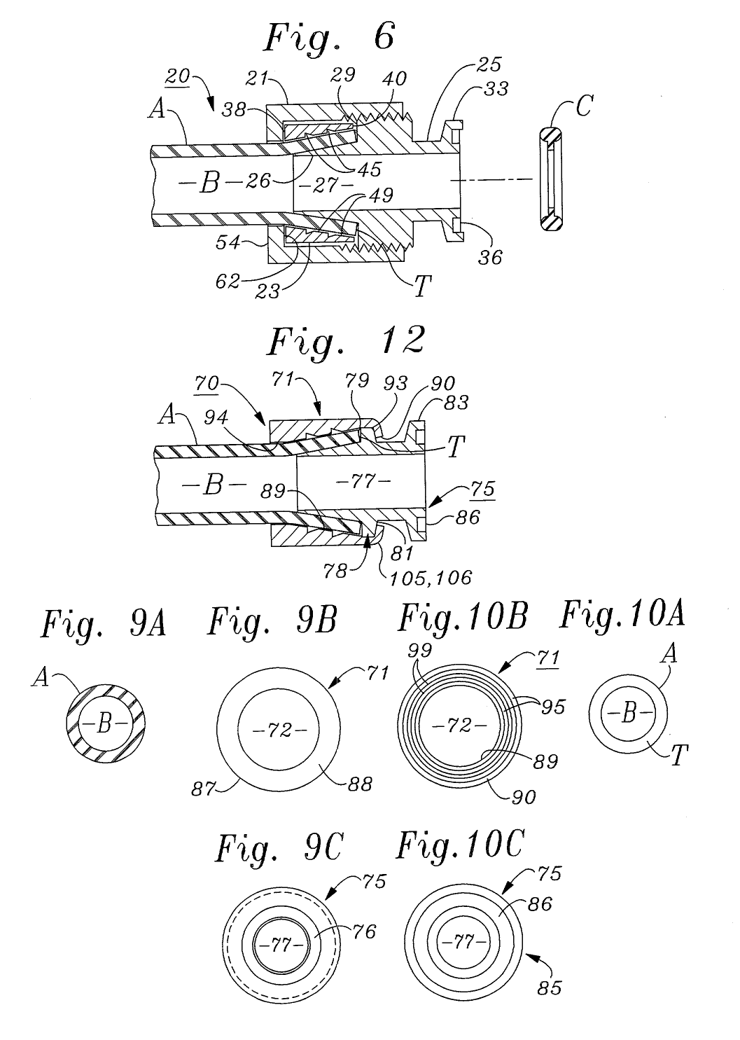

A preferred method of removably attaching removably attachable sanitary hose coupler 20 to a hose may be best understood by referring to FIGS. 5A-5D and 6 in addition to FIG. 1.

A first step in attaching sanitary hose coupler 20 to a hose A includes inserting an end of hose A 25 forwardly through bore 22 of compression nut 21, and then through bore 24 of compression ring 23, as shown in FIG. 5A. Next, as shown in FIG. 5B, nose piece 26 of connector body is forcibly inserted into bore B of hose A. As shown in FIG. 5D, compression nut 21 is then slid forward on hose A and over compression ring 23 sufficiently far forward for externally threaded portion 28 of connector body 25 to be received within the front, internally threaded portion of compression nut 21. A torque is then applied on compression nut 21 relative to connector body 25, to draw those elements axially together. This torque may be conveniently applied by a wrench slipped over notches 63 to engage flats 64. During the process of threadably tightening together compression nut 21 and connector body 25, a convenient way of applying a counter-torque to the connector body is by gripping the connector body with a toggle clamp F of the type shown in FIG. 1. Thus, as may be understood by referring to FIGS. 1, 5C and 5D, flange 33 of connector body 25 and a flange D of another coupler E are positioned face to face within a slot S of a toggle clamp F, and the toggle clamp closed and tightened as shown in FIG. 5C. Toggle clamp F may then be gripped by one of a person's hands while the other hand is used to apply torque through wrench W to compression nut 21, as shown in FIG. 5D.

Referring now primarily to FIG. 6, it may be understood that threadably tightening connector body 25 into compression nut 21 longitudinally contracts the spacing between inner, rear shoulder wall 29 of the connector body, and front annular surface 62 of rear flange wall 54 of the compression nut. This contraction causes front annular surface 62 of rear compression nut flange wall 54 to press in a longitudinally forward direction against rear transverse end wall 38 of compression ring 23. The longitudinally forward directed force on rear end wall 38 of compression ring 23 in turn causes frusto-conically tapered inner wall surface 39 of the compression ring to press tightly against the frusto-conically deformed outer wall surface of hose A, forcing shoulders 48 adjacent to ridges 49 in the inner wall surface of the compression ring to “dig in” to the outer wall surface of the hose, and those portions of the hose located between the ridges to cold flow into grooves 45 between the ridges. Thus installed, removably attachable sanitary hose coupler 20 according to the present invention forms a fluid pressure-tight seal with hose A. Importantly, as shown in FIG. 6, the fluid pressure-tight seal between coupler 20 and hose A is devoid of any cavities in a liquid product flow path through bore B of the hose and bore 27 of the coupler; the absence of any such cavities guarantees that there are no places in the coupler which might serve as traps for liquid product.

Referring now to FIGS. 7-12, a permanently attachable sanitary hose coupler 70 according to the present invention may be seen to include a coaxially alignable set of two circularly symmetric component parts, including a rear or longitudinally inwardly located compression sleeve 71 which has through it length a longitudinally disposed circular cross section coaxial bore 22 which is adapted to insertably receive a hose A, and a front or longitudinally outwardly located connector body 75 which has a rear frusto-conically-shaped nose piece 76 which is adapted to be forcibly inserted into bore B of hose A.

As shown in FIGS. 7, 8, 9C and 10C, connector body 75 has a hollow tubular shape and has disposed longitudinally through its length a cylindrical circular bore 77 of uniform diameter. Connector body 75 also has a relatively short cylindrically-shaped front tubular portion 82 which is terminated at a front or outer longitudinal end thereof by an annular ring-shaped front or outer connector flange 83 that has a frusto-conically shaped rear transverse end wall 84 and a flat front transverse end wall 85 in which is formed a concentric annular ring-shaped groove 86. Front tubular portion 82 of connector body 75 is terminated at a rear or inner longitudinal end thereof by a radially outwardly protruding, annular ring-shaped rear locking flange 78, which has a rear transversely disposed shoulder 79. Locking flange 78 also has a frusto-conically tapered front annular ring-shaped transversely disposed front end face 81 which joins the rear locking flange to front tubular portion 82 of connector body 75. Tubular front portion 82 of connector body 75 has a smooth outer cylindrical wall surface of a uniform outer diameter approximately the same as the outer diameter of the front end of rear frusto-conically-shaped nose piece 76. Nose piece 76 protrudes rearwardly from rear transversely disposed shoulder 79 of rear locking flange 78. Also, nose piece 76 has a smooth outer wall surface of the proper size to be insertably receivable into the bore of a flexible hose or tube sufficiently far for the front or outer transverse end wall of the hose to butt up against rear shoulder 79 of rear locking flange 78.

Referring now to FIGS. 9B and 10B in addition to FIGS. 7 and 8, it may be seen that compression sleeve 71 of removably attachable sanitary hose coupler 70 according to the present invention has a cylindrical outer surface 87, a rear or inner longitudinally located transverse end wall 88, and a frusto-conically tapered inner wall surface 89 which tapers radially outwardly to a front or outer longitudinal transverse end wall 90 which has a larger inner diameter than the rear transverse end wall. As shown in FIG. 8, the cone angle J of tapered inner wall surface 89 is preferably larger than that of cone angle K of connector body nose piece 76, for a reason which will be described below. In an example embodiment of coupler 70, tapered inner wall surface 89 of compression sleeve 71 had a cone angle J of about 7 degrees ±2 degrees, and connector body nose piece 76 had a cone angle K of about 6 degrees ±2 degrees, for a hose made of reinforced silicone or Teflon® and having an inner diameter of 5/8 inches and a wall thickness of about 0.170 inch. It is believed that the cone angles G and H should be increased about one degree for each inch increase in the inner diameter of hose A. However, hoses made of harder, less flexible materials such as Teflon® require somewhat smaller cone angles. In any event, the exact value of cone angles is not extremely critical, and the adjustment of the cone angles to suite hose materials of a given pliability may be readily made by those skilled in the art, in view of the present disclosure.

Referring still to FIG. 8, it may be seen that tapered inner wall surface 89 of compression sleeve 71 is preferably modified by cylindrical front and rear entrance counterbores 91 and 92, respectively, which form relatively short, cylindrically shaped, untapered portions 93 and 94, respectively, in tapered inner wall surface 39. As shown in FIG. 2, tapered inner wall surface 89 of compression ring 73 has formed therein a longitudinally spaced apart sequence of radially inwardly protruding, annular ring-shaped, triangular cross section grooves 95. Each groove 95 has a generally transversely disposed rear edge 96, and a longer oblique edge 97 which angles radially outwardly and forward from the rear edge to an uncut portion of inner wall surface 89. Thus, each groove 95 has at a rear or inner longitudinal end thereof a shoulder 98 formed by the intersection of transversely disposed rear edge 96 of the groove with tapered inner wall surface 89. Shoulder 98 has a relatively sharp vertex angle, being about 90 degrees plus one-half the cone angle J. On the other hand, oblique edge 97 of each groove 95 intersects tapered inner wall surface 89 at a relatively large obtuse angle.

The uncut portion of tapered inner wall surface 89 between each intersection of an oblique side 97 of groove 95 with the inner wall surface, and the rear transverse edge wall 96 of an adjacent, longitudinally outwardly spaced apart groove, forms a ridge 99. Although the exact number of grooves 95 formed in inner tapered wall surface 89 of compression ring 73 is not critical, preferably as shown in FIG. 8, the compression ring has at least two longitudinally spaced apart grooves 95 which form therebetween a ridge 99. It should be noted that tapered, uncut portion 101 of inner wall surface 89 forward of front groove 95F has a shape similar to those of ridges 99, and serves a similar function, as will be described in detail below.

A preferred method of permanently attaching permanently attachable sanitary hose coupler 70 to a hose may be best understood by referring to FIGS. 7, 8, 11A-11D, 12, and 13-15.

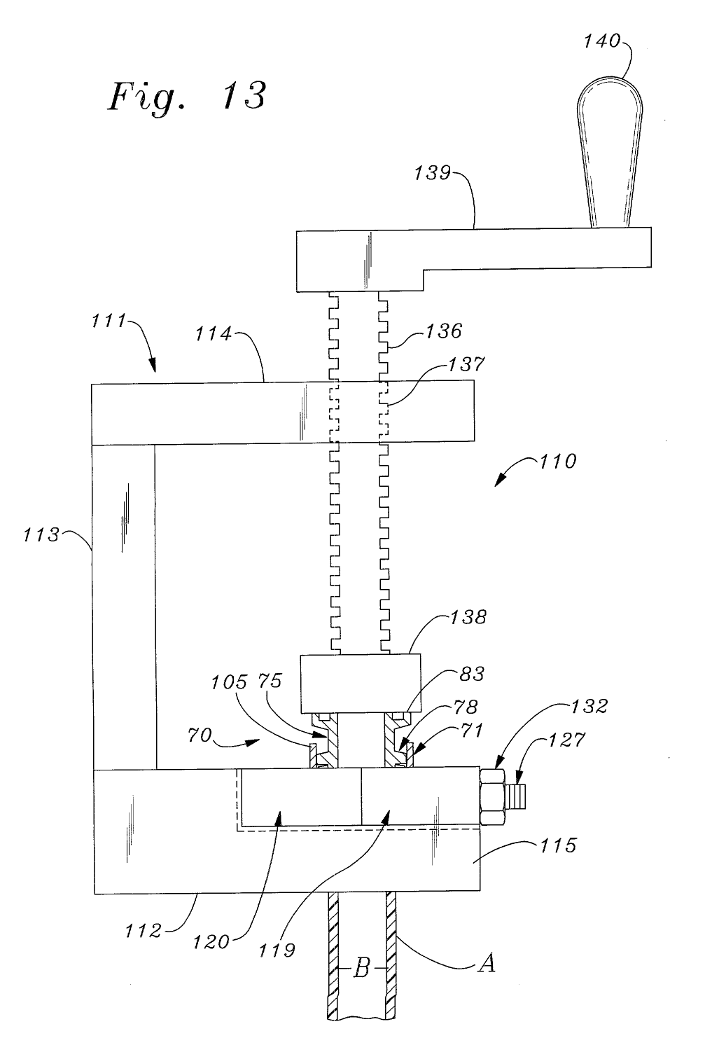

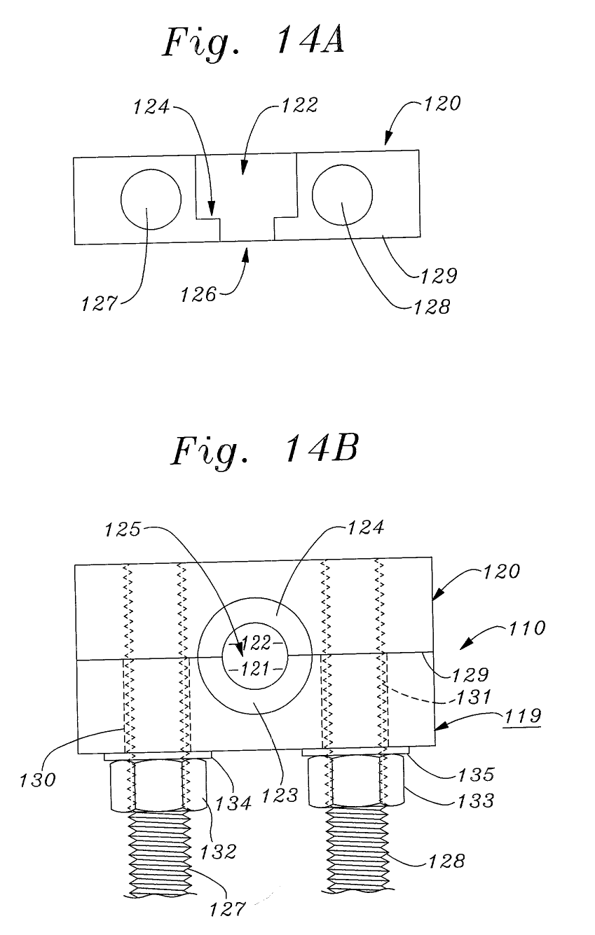

As shown in FIG. 11A, a first step in attaching sanitary hose coupler 70 to a hose A includes inserting an end of hose A forwardly through bore 72 of compression sleeve 71. Next, as shown in FIG. 11B, nose piece 76 of connector body 75 is forcibly inserted into bore B of hose A. Connector body 75 and compression sleeve 71 are then squeezed together by exerting a longitudinally inwardly directed compressive force couple on front transverse surface 85 of connector body flange 83, and rear transverse end wall 88 of compression sleeve 71, respectively. This force may be conveniently applied by a press, such as press 110 of FIGS. 13, 14A, 14B, and 15.

A final step in installing permanently attachable sanitary hose coupler 70 to a hose consists of permanently deforming an outer end portion 105 of the cylindrical wall 104 of compression sleeve 71 which protrudes forward or longitudinally outwards of front transverse end wall of rear connector body locking flange 78, thus forming an angled locking lip flange 106 which presses against the front surface of the rear connector body locking flange, thereby permanently securing the compression sleeve into locking engagement with the connector body. Deformation of compression sleeve end wall 105 to form an annular locking lip flange 106 may be accomplished in the manner illustrated in FIG. 15. As shown in FIG. 15, deformation of end wall 105 of compression sleeve 71 is accomplished by impacting the end wall with a punch 120 which has in a front surface 121 thereof a notch 122 shaped complementarily to the desired outer contour of locking lip flange 106. The rear surface 123 of punch 120 is impacted by a hammer 124 as the hammer and punch are orbited circumferentially around the sleeve end wall. Alternatively, the compression sleeve end wall can be deformed by a ring-shaped die, which optionally can be incorporated into the press used to press the compression sleeve and connector body together.

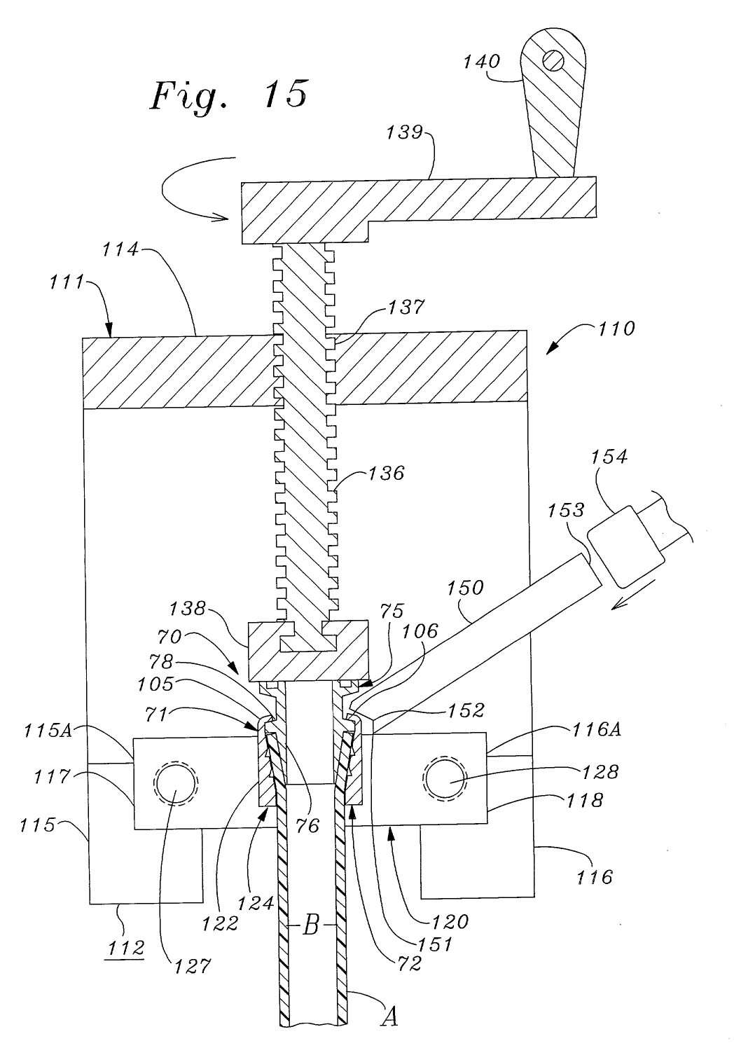

Referring now primarily to FIG. 12, it may be understood that pressing connector body 75 and compression sleeve 71 longitudinally together contracts the spacing between inner, rear shoulder wall 79 of the connector body, and rear wall 88 of the compression sleeve. This contraction causes ribs 99 of inner wall surfaces 89 of compression sleeve 71 to press in a longitudinally forward direction against the frusto-conically deformed outer wall surface of hose A, forcing shoulders 98 adjacent to ridges 99 in the inner wall surface of the compression sleeve to “dig in” to the outer wall surface of the hose, and those portions of the hose located between the ridges to cold flow into grooves 95 between the ridges. Thus installed, permanently attachable sanitary hose coupler 70 according to the present invention forms a fluid pressure-tight seal with hose A. Importantly, as shown in FIG. 12, the fluid pressure-tight seal between coupler 70 and hose A is devoid of any cavities in a liquid product flow path through bore B of the hose and bore 77 of the coupler; the absence of any such cavities guarantees that there are no places in the coupler which might serve as traps for liquid product.

What is claimed is:

1. A sanitary hose coupler attachable in a fluid pressure-tight connection to a resiliently deformable hose for conveying a liquid products under pressure, and releasably coupleable in a fluid pressure-tight coupling to a separate coupling member, said coupler comprising;
a. a circular cross-section, elongated tubular connector body having disposed through its length a bore and at a first, rear longitudinal end thereof a frusto-conically shaped nose piece which tapers rearwardly to a smaller diameter, and a front transversely disposed connector flange for releasably coupling to a separate coupling member.
b. a hollow cylindrical compression member which has a generally cylindrically-shaped outer wall surface and a central frusto-conically shaped bore bordered by a frusto-conically tapered inner wall surface which tapers rearwardly to a smaller diameter, and
c. clamping means for exerting a longitudinally directed compression force couple forwardly on said compression member and rearwardly on said connector body, whereby
d. an end of a resilient hose is insertable forwards through said bore of said compression member, said nose piece of said connector body is forcibly insertable rearwardly into a front entrance opening of a bore longitudinally disposed through said hose to thereby deform inner and outer cylindrical wall surfaces of an end portion of said hose to radially outwardly and forwardly tapered shapes, and said clamping means operated to force said inner tapered wall surface of said compression member against said deformed outer wall surface of said front end portion of said hose to make therewith a fluid pressure-tight seal.

2. The hose coupler of claim 1 wherein said frusto-conically shaped bore of said compression member has a larger cone angle than that of said frusto-conically shaped nose piece of said connector body.

3. The hose coupler of claim 1 wherein said cone angle of said compression member bore is about 7 degrees ±2 degrees.

4. The hose coupler of claim 3 wherein said cone angle of said nose piece is less than that of said compression member bore.

5. The hose coupler of claim 1 wherein said tapered inner wall surface of said compression member is further defined as having formed therein a plurality of longitudinally spaced apart grooves, said grooves being adapted to receive resiliently deformable portions of an outer wall of a hose to thereby effect an enhance fluid pressure-tight seal between said inner wall surface of said compression member and said outer wall surface of said hose.

6. The hose coupler of claim 3 wherein said tapered inner wall surface of said compression member is further defined as having formed therein at least one radially inwardly protruding ridge located between at least one pair of said grooves, said ridge being adapted to resiliently indent an outer wall surface of said hose to thereby effect an enhanced fluid pressure-tight seal between said tapered inner wall surface or said compression member and said hose.

7. The hose coupler of claim 1 wherein said clamping means for exerting a longitudinally directed compressive force couple on said compression member and said connector body is further defined as comprising in combination;
a. an externally threaded cylindrical section of said body located longitudinally between said front connector flange and said nose piece thereof, and
b. a compression nut which has a rear annular flange through which is formed a coaxial hose bore, and a hollow cylindrical space within said compression nut which has a rear portion having a diameter greater than that of said compression member and a length greater than that of said compression member, and a front hollow cylindrical portion provided with internal helical threads adapted to threadably receive said external threads of said connector body, and
c. whereby said threaded portion of said connector body is threadable into said threaded front portion of said compression nut, and said compression nut and said connector body are threadably tightenable together so that a front inner surface of said rear flange of said compression nut exerts a forward directed force on said compression ring.

8. The hose coupler of claim 1 wherein said clamping means for exerting a longitudinally directed compressive force couple on said compression member and said connector body is further defined as comprising in combination,
a. a rear locking flange which protrudes radially outwardly from said connector body between said nose piece and said front connector flange, and
b. a front tubular portion of said hollow cylindrical compression member which extends longitudinally forward of a front transverse surface of said rear locking flange, said front tubular portion being deformed radially inwardly into locking compressive contact with a front transverse surface of said rear locking flange.

9. A sanitary hose coupler removably attachable in a fluid-tight connection to a flexible, resiliently deformable hose useable to convey liquid products under pressure, and releasably coupleable in a fluid pressure-tight coupling to a mating flange of a separate coupling member, said coupler comprising;
a. a circular cross section, tubular connector body having at a first, rear longitudinal end thereof a frusto-conically shaped nose piece which tapers rearwardly to a smaller diameter, a front transversely disposed annular ring-shaped flange having a transversely disposed front face, and an externally threaded cylindrical portion located longitudinally between said front connector flange and said rear nose piece,
b. a compression ring which has a generally cylindrically-shaped outer wall surface, and a central coaxial bore bordered by a frusto-conically tapered inner wall surface which tapers rearwardly to a smaller, inner diameter, and
c. a compression nut which has a rear annular flange through which is formed a coaxial hose bore, and a hollow cylindrical space within said nut which has a rear portion, and a front portion provided with internal helical threads and adapted to threadably receive said external threads of said connector body, said rear portion of said compression nut having a diameter greater than that of said compression ring, and a length greater than that of said compression ring, whereby
d. an end of a flexible hose is insertable forward through said bores of said compression nut and said compression ring, said nose piece of said connector body is forcibly insertable rearwardly into an entrance bore of said hose to thereby deform inner and outer cylindrical wall surfaces of an end portion of said hose to radially outwardly and forwardly tapered shapes, said threaded portion of said connector body is threadable into said threaded front portion of said compression nut, and said compression nut and said connector body are threadably tightenable together so that a front inner surface of said rear flange wall of said compression nut exerts a forward directed force on said compression ring, whereby said tapered inner wall surface of said compression ring is pressable against said deformed outer wall surface of said front end portion of said hose to make therewith a fluid pressure-tight seal.

10. The sanitary hose coupler of claim 9 wherein said tapered inner wall surface of said compression ring is further defined as having formed therein a plurality of longitudinally spaced apart grooves, said grooves being adapted to receive resiliently deformable portions of an outer wall of a hose to thereby effect an enhanced fluid pressure-tight seal between said inner wall surface of said compression ring and said outer wall surface of said hose.

11. The sanitary hose coupler of claim 10 wherein said tapered inner wall surface of said compression ring is further defined as having formed therein at least one radially inwardly protruding ridge located between at least one pair of said grooves, said ridge being adapted to resiliently indent an outer wall surface of said hose to thereby effect an enhanced fluid pressure-tight seal between said tapered inner wall surface of said compression ring and said hose.

12. The sanitary hose coupler of claim 9 whereby said frusto-conically shaped bore of said compression ring has a larger cone angle than that of said frusto-conically shaped nose piece of said connector body.

13. A sanitary hose coupler attachable in a fluid-tight connection to a flexible, resiliently deformable hose useable to carry liquid products under pressure, and releasably coupleable in a fluid pressure-tight coupling to a mating flange of a separate coupling member, said coupler comprising;
a. a circular cross section, tubular connector body having at a first, rear longitudinal end thereof a rearwardly protruding frusto-conically shaped nose piece which tapers rearwardly to a smaller diameter, a front transversely disposed annular ring-shaped flange which has a transversely disposed front face, and rear locking flange which protrudes radially outwardly from said connector body, said rear locking flange having a front shoulder, and a rear shoulder adjacent to said nose piece,
b. a compression sleeve which has a generally cylindrically-shaped outer wall surface, a central coaxial bore bordered by a frusto-conically tapered inner wall surface which tapers rearwardly to a smaller inner diameter, and a front annular ring-shaped thin wall portion which is radially inwardly deformable, whereby
c. an end of a flexible hose is insertable forward through said bore of said compression sleeve, said nose piece of said connector body is forcibly insertable rearwardly into an entrance bore of said hose to thereby deform inner and outer wall surfaces of an end portion of said hose to radially outwardly and forwardly tapered shapes, said connector body and said compression sleeve are compressible longitudinally together sufficiently far for said front thin wall portion of said compression sleeve to be translated longitudinally forward of said front shoulder of said locking flange and deformable radially inwardly into locking engagement with said front locking flange shoulder.

14. The sanitary hose coupler of claim 13 wherein said tapered inner wall surface of said compression sleeve is further defined as having formed therein a plurality of longitudinally spaced apart grooves, said grooves being adapted to receive resiliently deformable portions of an outer wall of a hose to thereby effect an enhanced fluid pressure-tight seal between said inner wall surface of said compression ring and said outer wall surface of said hose.

15. The sanitary hose coupler of claim 14 wherein said tapered inner wall surface of said compression sleeve is further defined as having formed therein at least one radially inwardly protruding ridge located between at least one pair of said grooves, said ridge being adapted to resiliently indent an outer wall surface of said hose to thereby effect an enhanced fluid pressure-tight seal between said tapered inner wall surface of said compression ring and said hose.

16. The sanitary hose coupler of claim 13 whereby said frusto-conically shaped bore of said compression sleeve has a larger cone angle than that of said frusto-conically shaped nose piece of said connector body.
